(19) United States
(12) Patent Application Publication
(10) Pub. No.: US 2009/0278851 A1
(43) Pub. Date: Nov. 12, 2009

(54) METHOD AND SYSTEM FOR ANIMATING AN AVATAR IN REAL TIME USING THE VOICE OF A SPEAKER

(75) Inventors: Laurent Ach, Paris (FR); Serge Vieillescaze, Maurs (FR); Benoit Morel, Albuquerque, NM (US)

Correspondence Address: BANNER & WITCOFF, LTD., 1100 13th STREET, N.W., SUITE 1200, WASHINGTON, DC, 20005-4051, US

(73) Assignee: LA CANTOCHE PRODUCTION, S.A., Paris (FR)

(21) Appl. No.: 12/441,293

(22) PCT Filed: Sep. 14, 2007
(86) PCT No.: PCT/FR2007/001495

§ 371 Date: May 26, 2009

(30) Foreign Application Priority Data
Sep. 15, 2006 (FR) 0608078

(51) Int. Cl. G06T 15/70

(52) U.S. Cl. 345/473

(57) ABSTRACT

This is a method and a system for animating on a screen (3, 3′, 3″) of a mobile apparatus (4, 4′, 4″) an avatar (2, 2′, 2″) furnished with a mouth (5, 5′) using an input sound signal (6) corresponding to the voice (7) of a speaker (8) having a telephone communication. The input sound signal is transformed in real time into an audio and video stream in which the movements of the mouth of the avatar are synchronized with the phonemes detected in said input sound signal, and the avatar is animated in a manner consistent with said signal by changes of posture and movements by analysing said signal, so that the avatar seems to talk in real time or substantially in real time instead of the speaker.

The present invention relates to a method for animating an avatar in real time based on the voice of an interlocutor.

It also relates to a system for animating such an avatar.

The invention finds a particularly significant, although not exclusive, use, in the field of mobile apparatus such as mobile telephones or more generally Personal Digital Assistant apparatus (known as PDA).

Improving mobile telephones, their appearance and the quality of the images and sound they convey is a matter of constant concern to the makers of this type of apparatus.

The user thereof is very much alive to the personalization of this tool which has become an essential medium of communication.

However, even if it has come to have multiple functionalities, since it can now be used to store sounds and in particular photographic images, in addition to its prime function as a telephone, it is still nonetheless a restricted platform.

It cannot in particular be used to display high definition images, which will not be viewable in any way given the reduced dimension of its screen.

Furthermore, many services, accessible by mobile telephones operating hitherto in audio mode only, now find themselves having to meet a demand in viewphone mode (messaging service, customer call centre, etc.,).

The service providers originating these services often do not have a ready-made solution for switching over from audio to video and/or do not want to broadcast the image of a real person.

One of the solutions to these problems consequently lies in moving towards the use of avatars, in other words, the use of schematic and less complex graphical images representing one or more users.

Such graphics can therefore be pre-integrated into the telephone and then be called upon as required during a telephone conversation.

A system and a method are thus known (WO 2004/053799) for implementing avatars in a mobile telephone enabling them to be created and altered using the Extensible Markup Language (or XML) standard.

A system of this kind cannot however be used to determine the control of the facial expressions of the avatar as a function of the interlocutor, particularly in a synchronized way.

The best we can say is that programs exist in the prior art (EP 1 560 406) that enable the state of an avatar to be altered in a straightforward way based on external information generated by a user, but without the subtlety and speed needed in the situation where the avatar is required to behave in a way that is perfectly synchronized with the sound of a voice.

Present-day dialogue technologies and programs that use avatars, such as for example those employing a program developed by the American Company Microsoft known as “Microsoft Agent”, do not in fact allow the behaviour of an avatar to be reproduced effectively in real time relative to a voice, on portable apparatus of limited capacities such as a mobile telephone.

A method is also known (GB 2 423 905) for animating an entity on a mobile telephone that involves selecting and digitally processing the words of a message from which “visemes” are identified which are used to alter the mouth of the entity when the voice message is issued.

Such a method, apart from the fact that it is based on the use of words, and not sounds as such, is limited and gives a mechanical aspect to the visual image of the entity.

The present invention sets out to provide a method and a system for animating an avatar in real time that meet the requirements of practical use better than those previously known, and in particular in that it can be used to animate in real time not only the mouth, but also the body of an avatar on a piece of small capacity mobile apparatus such as a mobile telephone, and with excellent movement synchronization.

With the invention, it will be possible, while operating in the standard computer terminal or mobile communications environment, and without installing specialized software components in the mobile telephone, to obtain an animation of the avatar, in real or quasi-real time, that is consistent with the input signal, and to do so solely by detecting and analyzing the sound of the voice, in other words the phonemes.

High aesthetic and artistic quality is thus conferred on the avatars and on the movement thereof when they are created and this is done while respecting the complexity of the tone and subtleties of the voice, for a low cost and with excellent reliability.

To do this the invention departs in particular from the idea of using the richness of the sound or just the words themselves.

To this end the present invention proposes in particular a method for animating on the screen of a mobile apparatus an avatar provided with a mouth based on an input sound signal that corresponds to the voice of a telephone communication interlocutor, characterized in that the input sound signal is converted in real time into an audio and video stream in which on the one hand the mouth movements of the avatar are synchronized with the phonemes detected in said input sound signal, and on the other hand at least one other part of the avatar is animated in a way consistent with said signal by changes of attitude and movements through analysis of said signal, and in that in addition to the phonemes, the input sound signal is analyzed in order to detect and to use for the animation one or more additional parameters known as level 1 parameters, namely mute times, speak times and/or other elements contained in said sound signal selected from prosodic analysis, intonation, rhythm and/or tonic accent, so that the whole avatar moves and appears to speak in real time or substantially in real time in place of the interlocutor.

Other parts of the avatar are taken to be the body and/or the arms, the neck, legs, eyes, eyebrows, hair, etc., other than the mouth itself. These are not therefore set in motion independently of the signal.

Nor is it a question here of detecting the (real) emotion of an interlocutor from his voice but of mechanically creating reactions that are probable and artificial, but nonetheless credible and compatible with what the reality could be.

In advantageous embodiments use is made moreover of one and/or other of the following arrangements:
the avatar is chosen and/or configured through an on-line service on the Internet network;
the mobile apparatus is a mobile telephone;
to animate the avatar, elementary sequences are used, consisting of images generated by a 3D rendering calculation, or generated from drawings;
elementary sequences are stored in the memory at the start of animation and they are retained in said memory all through the animation for a plurality of simultaneous and/or successive interlocutors;
the elementary sequence to be played is selected in real time, as a function of pre-calculated and/or pre-set parameters;
since the list of elementary sequences is common to all the avatars that can be used in the mobile apparatus, an animation graph is defined whereof each node represents a point or state of transition between two elementary sequences, each connection between two transition states being unidirectional and all elementary sequences connected through one and the same state being required to be visually compatible with the switchover from the end of one elementary sequence to the start of the other;
each elementary sequence is duplicated so that a character can be shown that speaks or is idle depending on whether or not a voice sound is detected;
the phonemes and/or the other level 1 parameters are used to calculate so-called level 2 parameters namely and in particular the slow, fast, jerky, happy or sad characteristic of the avatar, on the basis of which said avatar is animated fully or in part;
since the level 2 parameters are taken as dimensions in accordance with which a set of coefficients is defined with values which are fixed for each state of the animation graph, the probability value for a state e is calculated as:

Pₑ=ΣPᵢ×Cᵢ

with Pᵢ the value of the level 2 parameter calculated from the level 1 parameters detected in the voice and Cᵢ the coefficient of the state e in accordance with the dimension i, this calculation being made for all the states connected to the state towards which the current state is leading in the graph;
when an elementary sequence is running the elementary sequence which is idle is left to run through to the end or a switchover is effected to the duplicated sequence which speaks in the event of voice detection and vice versa, and then, when the sequence ends and a new state is reached, the next target state is chosen in accordance with a probability defined by calculating the probability value of the states connected to the current state.

The invention also proposes a system that implements the method above.

It also proposes a system for animating an avatar provided with a mouth based on an input sound signal corresponding to the voice of a telephone communication interlocutor, characterized in that it comprises a mobile telecommunications apparatus, for receiving the input sound signal sent by an external telephone source, a proprietary signal reception server including means for analyzing said signal and converting said input sound signal in real time into an audio and video stream, calculation means provided on the one hand to synchronize the mouth movements of the avatar transmitted in said stream with the phonemes detected in said input sound signal and on the other hand to animate at least one other part of the avatar in a way that is consistent with said signal by changes of attitudes and movements,

in that it comprises input sound signal analysis means so as to detect and use for the animation one or more additional so-called level 1 parameters, namely mute times, speak times and/or other elements contained in said sound signal selected from prosodic analysis, intonation, rhythm and/or the tonic accent,

and in that it comprises means for transmitting the images of the avatar and the corresponding sound signal, so that the avatar appears to move and speak in real time or substantially in real time in place of the interlocutor.

These additional parameters are for example more than two in number, for example at least three and/or more than five.

To advantage the system comprises means for configuring the avatar through an online service on the Internet network.

In one advantageous embodiment it comprises means for constituting, and storing on a server, elementary animated sequences for animating the avatar, consisting of images generated by a 3-D rendering calculation, or generated from drawings.

To advantage it comprises means for selecting in real time the elementary sequence to be played, as a function of pre-calculated and/or pre-set parameters.

Also to advantage, since the list of elementary animated sequences is common to all the avatars that can be used in the mobile apparatus, it comprises means for the calculation and implementation of an animation graph whereof each node represents a point or state of transition between two elementary sequences, each connection between two states of transition being unidirectional and all the sequences connected through one and the same state being required to be visually compatible with the switchover from the end of one elementary sequence to the start of the other.

In an advantageous embodiment it comprises means for duplicating each elementary sequence so that a character can be shown that speaks or is idle depending on whether or not a voice is detected.

To advantage the phonemes and/or the other level 1 parameters are used to calculate so-called level 2 parameters which correspond to characteristics such as the slow, fast, jerky, happy, or sad characteristic or other characteristics of equivalent type and the avatar is animated at least partly from said level 2 parameters.

A parameter of equivalent type to a level 2 parameter is taken to be a more complex parameter designed from the level 1 parameters, which are themselves more straightforward.

In other words level 2 parameters involve analyzing and/or bringing together the level 1 parameters, which will allow the character states to be refined still further by making them more suitable for what it is desired to show.

Since the level 2 parameters are taken as dimensions in accordance with which a set of coefficients is defined with values which are fixed for each state of the animation graph, the calculation means are provided to calculate the probability value for a state e as:

Pₑ=ΣPᵢ×Cᵢ

with Pᵢ the value of the level 2 parameter calculated from the level 1 parameters detected in the voice and Cᵢ the coefficient of the state e in accordance with the dimension i, this calculation being made for all the states connected to the state towards which the running sequence is leading in the graph. When an elementary sequence is running let the elementary sequence which is idle run through to the end or switch to the duplicated sequence which speaks in the event of voice detection and vice versa, and then, when the sequence ends and a new state is reached, choose the next target state in accordance with a probability defined by calculating the probability value of the states connected to the current state.

The invention will be better understood by reading on about particular embodiments given hereinafter as non-restrictive examples.

The description refers to the accompanying drawings wherein:

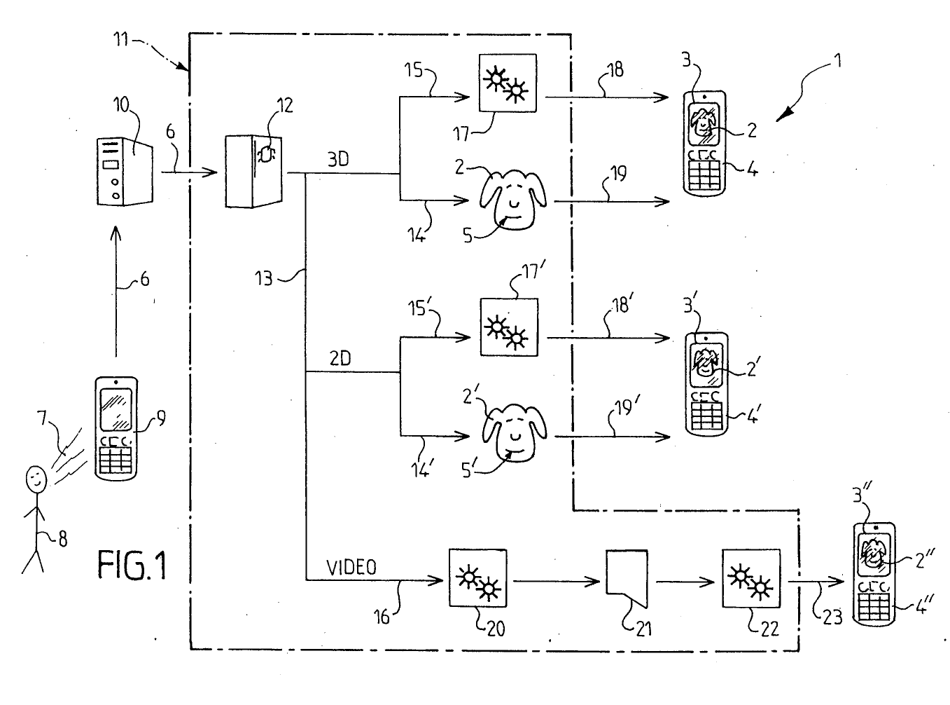

FIG. 1 is a block diagram showing an animation system for an avatar according to the invention,

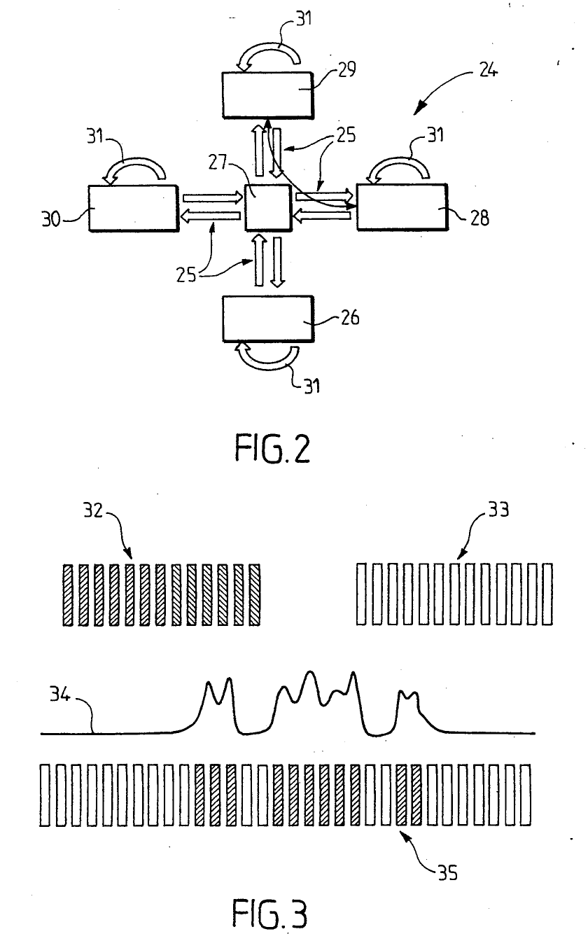

FIG. 2 gives a state graph as implemented according to the inventive embodiment more particularly described here.

FIG. 3 shows three types of image sequences, including the one obtained with the invention in relation to an input sound signal.

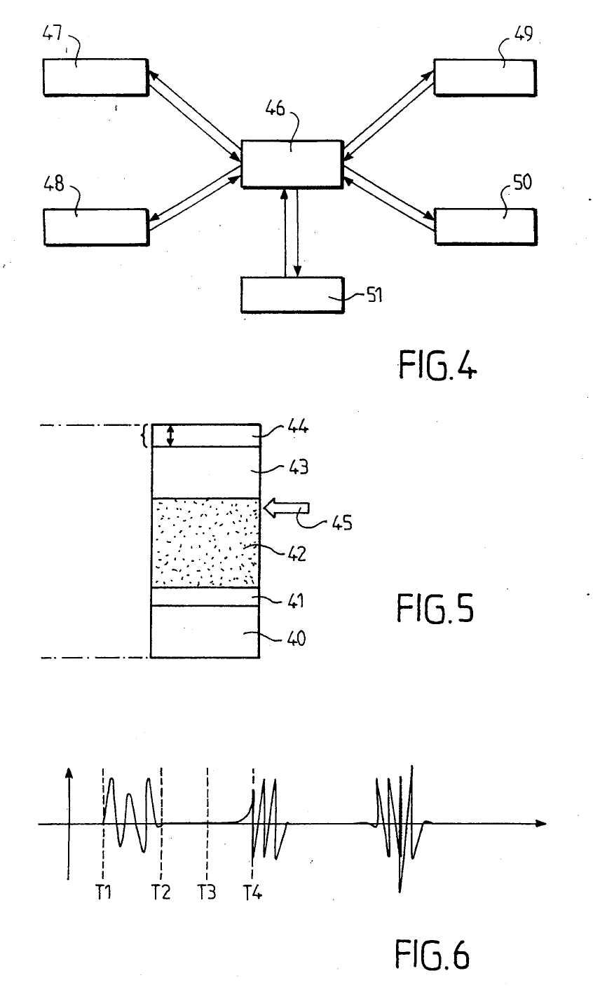

FIG. 4 shows diagrammatically another mode of implementing the state graph employed according to the invention.

FIG. 5 shows diagrammatically the method for selecting a state from the relative probabilities, according to one inventive embodiment.

FIG. 6 shows an example of an input sound signal allowing a sequence of states to be built, so that they can be used to build the behaviour of the inventive avatar.

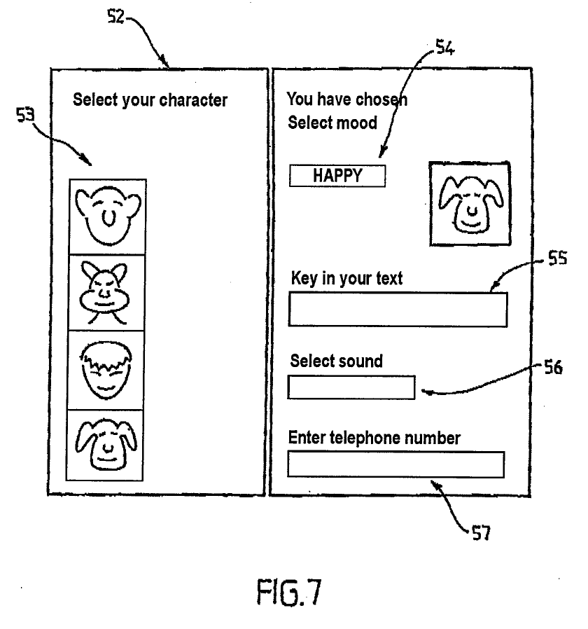

FIG. 7 shows an example of the initial parameterization performed from the mobile telephone of the calling interlocutor.

FIG. 1 shows diagrammatically the principle of an animation system 1 for an avatar 2, 2′ on a screen 3, 3′, 3″ of a mobile apparatus 4, 4′, 4″.

The avatar 2 is provided with a mouth 5, 5′ and is animated from an input sound signal 6 corresponding to the voice 7 of an interlocutor 8 communicating by means of a mobile telephone 9, or any other means of sound communication (fixed telephone, computer, etc).

The system 1 includes, based on a server 10 belonging to a network (telephone, Internet etc), a proprietary server 11 for receiving signals 6.

This server includes means 12 for analyzing the signal and converting said signal in real time into an audio and video multiplexed stream 13 in two voices 14, 15; 14′, 15′ in the case of a reception by 3-D or 2-D mobiles, or in a single voice 16 in the case of a so-called viewphone mobile.

It further includes calculation means provided to synchronise the movements of the avatar mouth 5 with phenomena detected in the input sound signal and to retransmit (in the case of a 2-D or 3-D Mobile) on the one hand the scripted text data at 17, 17′, then transmitted at 18, 18′ in script form to the mobile telephone 4; 4′, and on the other hand to download the 2-D or 3-D avatar, at 19, 19′ to said mobile telephone.

Where a so-called viewphone mobile is used, the text is scripted at 20 for transmission in the form of sound image files 21, before being compressed at 22 and sent to the mobile 4″, in the form of a video stream 23.

The result obtained is that the avatar 2, and particularly its mouth 5, appears to speak in real time in place of the interlocutor 8 and that the behaviour of the avatar (attitude, gestures) is consistent with the voice.

A more detailed description will now be given of the invention with reference to FIGS. 2 to 7, the method more particularly described allowing the following functions to be implemented:
using animated elementary sequences, consisting of images generated a by 3-D rendering calculation or else directly produced from drawings;
choosing and configuring ones character through an online service which will produce new elementary sequences: 3-D rendering on the server or selection of sequence categories;
storing all the elementary sequences in the memory, when the application is launched and keeping them in the memory throughout the duration of the service for a plurality of simultaneous and successive users;
analyzing the voice contained in the input signal to detect the mute times, the speak times and possibly other elements contained in the sound signal, such as the phonemes, the prosodic analysis (voice intonation, speech rhythm, tonic accents);
selecting in real time the elementary sequence to be played, as a function of the pre-calculated parameters.

The sound signal is analyzed from a buffer corresponding to a small interval of time (about 10 milliseconds). The choice of elementary sequences (by what is known as the sequencer) is explained below.

To be more precise and to obtain the results sought by the invention, the first thing is to create a list of elementary animation sequences for a set of characters.

Each sequence is constituted by a series of images produced by 3-D or 2-D animation software known per se, such as 3daMax and Maya software for example from the American company Autodesk and XSI from the French company Softimage, or otherwise by conventional proprietary 3-D rendering tools, or else constituted by digitised drawings. These sequences are pre-generated and put onto the proprietary server which broadcasts the avatar video stream, or else generated by the online avatar configuration service and put onto this same server.

In the embodiment more particularly described here the list of names of available elementary sequences is common to all the characters but the images composing them may represent very different animations.

This means that a state graph common to a plurality of avatars may be defined but this arrangement is not mandatory.

A graph 24 of states is then defined (cf. FIG. 2) whereof each node (or state) 26, 27, 28, 29, 30 is defined as a point of transition between elementary sequences.

The connection between two states is unidirectional, in one direction or in the other (arrows 25).

To be more precise, in the example in FIG. 2, five states have been defined, namely the sequence start 26, neutral 27, excited 28, at rest 29 and sequence end 30 states.

All the sequences connected through one and the same graph state must be visually compatible with the switchover from the end of one animation to the start of another. Compliance with this constraint is managed when creating the animations corresponding to the elementary sequences

Each elementary sequence is duplicated so that a character can be shown which speaks or else a character which is idle, depending on whether or not words have been detected in the voice.

This allows switching from one version to another of the elementary sequence that is running, so that the animation of the character's mouth can be synchronized with the speak times.

In FIG. 3 an image sequence has been shown as obtained with speech 32, the same sequence with no speech 33, and as a function of the sound input (curve 34) given out by the interlocutor, the resulting sequence 35.

The principle of animation sequence selection is now described below.

Voice analysis produces a certain number of so-called level 1 parameters, with the value thereof varying over time and the mean being calculated over a certain interval, for example of 100 milliseconds.

These parameters are, for example:
the speech activity (idle or speak signals)
the speech rhythm
the pitch (shrill or low) if a non-tonal language is involved
the length of the vowels
the more or less significant presence of tonic accent.

The speech activity parameter may be calculated at a first estimate, from the power of the sound signal (squared signal integral), considering that there is speech above a certain threshold. The threshold can be calculated dynamically as a function of the signal-to-noise ratio. Frequency filtering is also conceivable in order to prevent a passing lorry for example from being mistaken for the voice. The speech rhythm is calculated based on the average frequency of mute and speak times. Other parameters may also be calculated from a signal frequency analysis.

According to the inventive mode more particularly described here, simple mathematical formulae (linear combinations, threshold functions, Boolean functions) make it possible to switch from these level 1 parameters to so-called level 2 parameters which correspond to characteristics such as for example the slow, quick, jerky, happy, sad, characteristic etc.

Level 2 parameters are considered as dimensions in accordance with which a set of coefficients Cᵢ are defined with values fixed for each state e of the animation graph. Examples of a parameterisation of this kind are given below.

All the time, in other words with a frequency of 10 milliseconds for example, the level 1 parameters are being calculated. When a new state is to be chosen, in other words at the end of a sequence run, a calculation can therefore be made of the level 2 parameters which can be inferred from them as can a calculation of the following value for a state e: Pₑ=ΣPᵢ×Cᵢ where the values pᵢ are those of the level 2 parameters and cᵢ the coefficients of the state e in accordance with the dimension i.

This sum constitutes a relative probability of the state e (relative to the other states) of being selected.

When an elementary sequence is running, it is then left to run right to the end, in other words as far as the state of the graph to which it is leading but a switchover is made from one version of the sequence (version with or without speech) to the other at any moment as a function of the speech signal detected.

When the sequence ends and a new state is reached, the next target state is chosen in accordance with a probability defined by the previous calculations. If the target state is the same as the current state, you remain there playing a loop animation a certain number of times thereby returning to the previous situation.

Some sequences are loops which leave one state and return to it (Arrow 31). They are used when the sequencer decides to hold the avatar in its current state, in other words, chooses as the next target state the current state itself.

There follows below a description in pseudo-code of an example of animation generation and a description of an example of a sequence run:

### Example of Animation Generation

initialize current state at a predefined start state
initialize target state at nil
initialize current animation sequence at nil sequence
as long as an incoming audio stream is received:
   decode the incoming audio stream
   calculate the level 1 parameters
if current animation sequence terminated:
current animation sequence=nil sequence
   target state=nil state
oif target state nil:
   calculate level 2 parameters as a function of level 1 parameters (and possibly the log thereof)
select the states connected to the current state
   calculate probabilities of these connected states as a function of their coefficients and level 2 parameters previously calculated
   drawing the target state from among these connected states as a function of the pre-calculated probabilities=>a new target state is thus defined
if current animation sequence nil:
   select in the graph the animation sequence from the current state to the target state=>defines the current animation sequence
run the current animation sequence=>selection of corresponding pre-calculated images
match up incoming audio stream portion and the selected images based on the analysis of said audio stream portions
generate a compressed audio and video stream from the selected images and from the incoming audio stream

### Example of Sequence Run

the interlocutor says: “Hi, how are you?”:

1.the level 1 parameters indicate the presence of speech

2.the level 2 parameters indicate: cheerful voice (corresponding to “Hi”)

3.probability drawing selects the happy target state

4.the animation sequence is run from the start state to the happy state (in its version with speech)

5.the mute time is reached, recognized through the level 1 parameters

6.the animation sequence is still running, it is not interrupted but its non-speech version is selected

7.the happy target state is reached

8.the mute time leads to the neutral target state being selected (through the calculation of the level 1 and 2 parameters and the probability drawing)

9.the animation sequence is run from the happy state to the neutral state (in its non-speech version)

10.the neutral target state is reached

11.the mute time leads again to the neutral target state being selected

12.the neutral=>neutral animation sequence (loop) is run in its non-speech version

13.the level 1 parameters indicate the presence of speech (corresponding to “How are you?”)

14.the level 2 parameters indicate an interrogative voice

15.the neutral target state is again reached

16.the interrogative target state is selected (through the calculation of the level 1 and 2 parameters and the probability drawing)

17.etc.,

The method of selecting a state from the relative probabilities is now described with reference to FIG. 5 which gives a probability graph for states 40 to 44.

The relative probability of the state 40 is determined relative to the abovementioned calculated value.

If the value (arrow 45) is at a set level, the corresponding state is selected (in the figure, state 42).

With reference to FIG. 4, another example is given of an inventive state graph.

In it the following states have been defined:
neutral state (Neutral): 46
state appropriate to a first speak time (speak 1): 47
another state appropriate to a second speak time (speak 2): 48
state appropriate to a first mute time (Idle 1): 49
another state appropriate to a second mute time (Idle 2): 50
state appropriate to an introductory remark (greeting): 51

The state graph connects all these states unidirectionally (in both directions) in the form of a star (link 52).

In other words, in the example more particularly described with reference to FIG. 4, the dimensions are defined as follows, for the calculation of the relative probabilities (dimensions of the parameters and coefficients).

IDLE: values indicating a mute time

SPEAK: values indicating a speak time

NEUTRAL: values indicating a neutral time

GREETING: values indicating a greeting or introductory phase.

First level parameters are then introduced, detected in the input signal and used as intermediate values for the calculation of the previous parameters, namely:
Speak: binary value indicating whether speech is occurring
SpeakTime: length of time elapsed since the start of speak time
MuteTime: length of time elapsed since the start of mute time
SpeakIndex: speak time number since a set moment

The formulae are also defined that allow a switch from first level parameters to those of the second level:
IDLE: NOT (Speak)×MuteTime
SPEAK: Speak
NEUTRAL: NOT (Speak)
GREETING: Speak & (SpeakIndex −1)

The coefficients associated with the states are for example given in Table I below:

TABLE I

| | IDLE | SPEAK | NEUTRAL | GREETING |
|---|---|---|---|---|
| Neutral | 0 | 0 | 1 | 0 |
| Speak1 | 0.05 | 1 | 0 | 0 |
| Speak2 | 0 | 1.2 | 0 | 0 |
| Idle1 | 2 | 0 | 0 | 0 |
| Idle2 | 1 | 0 | 0 | 0 |
| Greeting | 0 | 0.5 | 0 | 1 |

A parameterization of this kind, with reference to FIG. 6, and for four moments T1, T2, T3, T4, gives the current state and the values of the level 1 and 2 parameters in Table II below.

TABLE II

| | |
|---|---|
| T1: Current state = Neutral | |
| Speak = 1 | IDLE = 0 |
| SpeakTime = 0.01 sec | SPEAK = 1 |
| MuteTime = 0 sec | NEUTRAL = 0 |
| SpeakIndex = 1 | GREETING = 1 |
| T2: Current state = Greeting | |
| Speak = 0 | IDLE = 0.01 |
| SpeakTime = 0 sec | SPEAK = 0 |
| MuteTime = 0.01 sec | NEUTRAL = 1 |
| SpeakIndex = 1 | GREETING = 0 |
| T3: Current state = Neutral | |
| Speak = 0 | IDLE = 0.5 |
| SpeakTime = 0 sec | SPEAK = 0 |
| MuteTime = 1.5 sec | NEUTRAL = 1 |
| SpeakIndex = 1 | GREETING = 0 |
| T4: Current state = Neutral | |
| Speak = 1 | IDLE = 0 |
| SpeakTime = 0.01 sec | SPEAK = 1 |
| MuteTime = 0 sec | NEUTRAL = 0 |
| SpeakIndex = 2 | GREETING = 0 |

The relative probability of the following states is then given in Table III below:

TABLE III

T1
Neutral = 0
Speak1 = 1
Speak2 = 1.2
Greeting = 2.5
Idle1 = 0
Idle2 = 0
T2
Neutral = 1
Speak1 = 0
Speak2 = 0
Greeting = 0
Idle1 = 0.02
Idle2 = 0.01
T3
Neutral = 1
Speak1 = 0
Speak2 = 0
Greeting = 0
Idle1 = 1
Idle2 = 0.5
T4
Neutral = 0
Speak1 = 1
Speak2 = 1.2
Greeting = 0
Idle1 = 0
Idle2 = 0

Which gives, in the example chosen, the probability drawing corresponding to table IV below:

TABLE IV

T1: Current state = Neutral
Speak1
Speak2
Greeting drawing
Next state = Greeting
T2: Current state = Greeting
Neutral drawing
Next state = Neutral
T3: Current state = Neutral
Neutral drawing
Idle1
Idle2
Next state = Neutral
T4: Current state = Neutral
Speak1
Speak2 drawing
Next state = Speak2

Lastly, with reference to FIGS. 7 and 1 the schematized screen 52 of a mobile has been shown that can be used to parameterize an avatar in real time.

At step 1, the user 8 configures the parameters of the video sequence he wants to personalize.

For example:

Character 53

Expression of character (happy, sad etc) 54

Reply style of character 55

Background sound 56

Telephone number of recipient 57

At step 2, the parameters are transmitted in the form of requests to the server application (server 11) which interprets them, crates the video and sends it (connection 13) to the encoding application.

At step 3, the video sequences are compressed in the “right” format, i.e. readable by mobile terminals prior to step 4 where the compressed video sequences are transmitted (connections 18, 19, 18′, 19′; 23) to the recipient by MMS for example.

It goes without saying, and as can be seen from what has been said above, the invention is not restricted to the embodiment more particularly described but on the contrary encompasses all alternatives and particularly those where broadcasting occurs off-line and not in real or quasi-real time.

1. Method for the animation on a screen (3, 3′, 3″) of a mobile apparatus (4, 4′, 4″) of an avatar (2, 2′, 2″) provided with a mouth (5, 5′) based on an input sound signal (6) corresponding to the voice (7) of an telephone conversation interlocutor (8), characterized in that
the input sound signal is converted in real time into an audio and video stream in which on the one hand the mouth movements of the avatar are synchronized with the phonemes detected in said input sound signal, and on the other hand at least one other part of the avatar is animated in a way consistent with said signal by changes of attitude and movements through analysis of said signal,
and in that in addition to the phonemes, the input sound signal is analyzed in order to detect and to use for the animation one or more additional parameters known as level 1 parameters, namely mute times, speak times and/or other elements contained in said sound signal selected from prosodic analysis, intonation, rhythm and/or tonic accent,
so that the whole avatar moves and appears to speak in real time or substantially in real time in place of the interlocutor.

2. Method as claimed in claim 1, characterized in that the avatar is chosen and/or configured through an online service on the Internet network.

3. Method as claimed in claim 1, characterized in that the mobile apparatus is a mobile telephone.

4. Method as claimed in claim 1, characterized in that, to animate the avatar, elementary sequences are used, consisting of images generated by a 3D rendering calculation, or generated from drawings.

5. Method as claimed in claim 4, characterized in that elementary sequences are stored in a memory at the start of animation and they are retained in said memory all through the animation for a plurality of simultaneous and/or successive interlocutors.

6. Method as claimed in claim 4, characterized in that the elementary sequence to be played is selected in real time, as a function of pre-calculated and/or pre-set parameters.

7. Method as claimed in claim 4, characterized in that, since the elementary sequences are common to all the avatars that can be used in the mobile apparatus, an animation graph is defined whereof each node represents a point or state of transition between two elementary sequences, each connection between two transition states being unidirectional and all elementary sequences connected through one and the same state being required to be visually compatible with the switchover from the end of one elementary sequence to the start of the other.

8. Method as claimed in claim 7, characterized in that each elementary sequence is duplicated so that a character can be shown that speaks or is idle depending on whether or not a voice sound is detected.

9. Method as claimed in claim 1, characterized in that the phonemes and/or the other level 1 parameters are used to calculate so-called level 2 parameters namely the slow, fast, jerky, happy or sad characteristic of the avatar, on the basis of which said avatar is animated fully or in part.

10. Method as claimed in claim 9, characterized in that, since the level 2 parameters are taken as dimensions in accordance with which a set of coefficients is defined with values which are fixed for each state of the animation graph, the probability value for a state e is calculated as:
Pₑ=ΣPᵢ×Cᵢ
with Pᵢ the value of the level 2 parameter calculated from the level 1 parameters detected in the voice and Cᵢ the coefficient of the state e in accordance with the dimension i,
and then when an elementary sequence is running
the elementary sequence which is idle is left to run through to the end or a switchover is effected to the other sequence which speaks in the event of voice detection and vice versa, and then, when the sequence ends and a new state is reached,
the next target state is chosen in accordance with a probability defined by calculating the probability values of the states connected to the current state.

11. System (1) for animating an avatar (2, 2′) provided with a mouth (5, 5′) based on an input sound signal (6) corresponding to the voice (7) of an telephone conversation interlocutor (8), characterized in that it comprises
a mobile telecommunications apparatus (9), for receiving the input sound signal sent by an external telephone source,
a proprietary signal reception server (11) including means (12) for analyzing said signal and converting said input sound signal in real time into an audio and video stream,
calculation means provided on the one hand to synchronize the mouth movements of the avatar transmitted in said stream with the phonemes detected in said input sound signal,
and on the other hand to animate at least one other part of the avatar in a way that is consistent with said signal by changes of attitude and movements,
and in that it further comprises input sound signal analysis means so as to detect and use for the animation one or more additional so-called level 1 parameters, namely mute times, speak times and/or other elements contained in said sound signal selected from prosodic analysis, intonation, rhythm and/or the tonic accent, so that the avatar moves and appears to speak in real time or substantially in real time in place of the interlocutor.

12. System as claimed in claim 11, characterized in that it comprises means for configuring the avatar through an online service on the internet network.

13. System as claimed in claim 11, characterized in that it comprises means for constituting, and storing in a proprietary server, elementary animated sequences for animating the avatar, consisting of images generated by a 3-D rendering calculation, or generated from drawings.

14. System as claimed in claim 13, characterized in that it comprises means for selecting in real time the elementary sequence to be played, as a function of pre-calculated and/or pre-set parameters.

15. System as claimed in claim 11, characterized in that, since the list of elementary sequences is common to all the avatars that can be used for sending to the mobile apparatus, it comprises means for the calculation and implementation of an animation graph whereof each node represents a point or state of transition between two elementary sequences, each connection between two states of transition being unidirectional and all the sequences connected through one and the same state being required to be visually compatible with the switchover from the end of one animation to the start of the other.

16. System as claimed in claim 11, characterized in that it comprises means for duplicating each elementary sequence so that a character can be shown that speaks or is idle depending on whether or not a voice sound is detected.

17. System as claimed in claim 11, characterized in that, since the phonemes and/or the other parameters are taken as dimensions in accordance with which a set of coefficients is defined with values which are fixed for each state of the animation graph, the calculation means are provided to calculate for a state e the probability value:
Pₑ=ΣPᵢ×Cᵢ
with Pᵢ the value of the level 2 parameter calculated from the level 1 parameters detected in the voice and Cᵢ the coefficient of the state e in accordance with the dimension i,
and then, when an elementary sequence is running, the elementary sequence which is idle is left to run through to the end or a switchover is effected to the other sequence which speaks in the event of voice detection and vice versa, and then, when the sequence ends and a new state is reached, the next target state is chosen in accordance with a probability defined by calculating the probability value of the states connected to the current state.
